(19) United States
(12) Patent Application Publication
(10) Pub. No.: US 2015/0035836 A1
(43) Pub. Date: Feb. 5, 2015

(54) DATA DISPLAY AND DATA DISPLAY METHOD

(71) Applicant: BIG FOREST PTY LTD, MELBOURNE (AU)

(72) Inventor: Reginald Victor Mifflin, Palmyra (AU)

(21) Appl. No.: 14/460,849

(22) Filed: Aug. 15, 2014

Related U.S. Application Data
(63) Continuation of application No. PCT/AU2013/000150, filed on Feb. 20, 2013.

(30) Foreign Application Priority Data
Feb. 20, 2012 (AU) 2012900617

(51) Int. Cl. G06T 11/20; G06F 17/30

(52) U.S. Cl. CPC G06T 11/206; G06F 17/30705; G06F 17/30619
USPC 345/440

(57) ABSTRACT

A method of displaying data is described. The method includes sorting documents in a data set into a set of categories, assigning an indicia to each category, displaying each document as one or more respective cell comprising a respective indicia, grouping the cells comprising an identical indicia and displaying each group of the grouped cells as a component of a complex object. Also described is a data display comprising a complex object comprising one or more group comprising grouped cells, each group representing a category in a set of categories and comprising a plurality of cells comprising an identical indicia, each cell representing a respective document. A corresponding system for displaying data and a computer program product comprising a computer usable medium and computer readable program code embodied on said computer usable medium for displaying data are also described.

### CROSS-REFERENCE TO RELATED APPLICATIONS

The present application is a continuation from and claims priority under 35 U.S.C. §120 and §365(c) to PCT Application No. PCT/AU2013/000150, filed Feb. 20, 2013, which claims priority from Australian Patent application No. 2012900617, filed Feb. 20, 2012, all herein incorporated by reference in their entireties.

### FIELD

This invention described herein relates generally to a data display and a data display method. In particular, the invention is directed to a data display and data display method for large data sets, although the scope of the invention is not necessarily limited thereto.

### BACKGROUND

In today's information age the enormous amounts of data available presents challenges in processing, storage, curation, and display. Rapid developments continue to be made that lead to increasing computing power. Similarly rapid developments have been made that allow storage of the enormous amounts of data created.

Graphic presentation helps to better understand, interrogate and navigate large amounts of information by replacing lists of text with pictures.

Charts, graphs, icons and other visual presentation are a help, but they are limited. Important data can be lost in a sea of irrelevant or unimportant data.

Other conventional visual display methods display multiple, sometimes hundreds, of individual items under the pretext that no significant visual information is lost. Another conventional display method is to display one or more abstract indicator such as, a triangle, to represent individual data items and their level in a multi-layer hierarchy and position is communicated by a change in display position to a trained observed. Both these methods require trained users and their complexity risks lack of recognition.

The methods have limitations and accordingly, advancements in data display are required.

### SUMMARY

A method of displaying data is disclosed herein and comprises: sorting documents in a data set into a set of categories; assigning an indicia to each category in the set of categories, wherein an identical indicia is assigned to each document sorted into a respective category; displaying each document as one or more respective cell comprising a respective indicia; grouping the cells comprising an identical indicia; and displaying each group of the grouped cells as a component of a complex object to thereby display the data.

### BRIEF DESCRIPTION OF THE DRAWINGS

In order that the present invention may be readily understood and put into practical effect, reference will now be made to the accompanying illustrations, wherein like reference numerals refer to like features and wherein:

FIG. 1A: shows one embodiment of the method of the invention.

FIG. 1B: shows another embodiment of the method of the invention.

FIG. 1C: shows another embodiment of the method of the invention.

FIG. 2A: shows one embodiment of a computer system suitable for use in the invention.

FIG. 2B: shows one embodiment of a computer memory and processor suitable for use in the invention.

FIG. 3: shows one embodiment of a display according to the invention.

FIG. 3′: shows the same embodiment of FIG. 3 in a black and white display. The legend or key for the black and white shadings to colour indication are show below the display. As shown in FIG. 3, two different shades of green 304, 312 and red pink 306, 314 are used. It is to be understood that the two different green 304, 312 and pink 306, 314 regions in FIG. 3′ comprise different indicia, groups and components.

FIGS. 4A-4L show a display according to another embodiment of the invention.

FIGS. 4A′-4L′ shows the same embodiment as FIGS. 4A-4L in a black and white display using the same legend as shown in FIG. 3′.

FIG. 5: shows one embodiment of a graphical user interface according to the invention.

FIG. 5′: shows the same embodiment as FIG. 5 in a black and white display using the same legend as shown in FIG. 3′.

FIG. 6: shows another embodiment of a display according to the invention.

FIG. 6′: shows the same embodiment as FIG. 6 in a black and white display using the same legend as shown in FIG. 3′.

FIG. 7 shows yet another embodiment of a display according to the invention.

FIG. 7′ shows the same embodiment as in FIG. 7 in a black and white display using the same legend as shown in FIG. 3′.

FIGS. 8A-8C show another embodiment of a display according to the invention.

FIGS. 8A′-8C′ show the same embodiment as in FIGS. 8A-8C in a black and white display using the same legend as shown in FIG. 3′.

FIG. 9 shows another embodiment of a display according to the invention.

FIG. 9′ shows the same embodiment as in FIG. 9 in a black and white display using the same legend as shown in FIG. 3′.

### DETAILED DESCRIPTION

The inventors have produced a method for displaying data that allows visualisation of large amounts of data and at the same time aids comprehension and data mining as well as recognition of patterns and prediction of events.

The present invention is broadly directed to a data display and data display method. A preferred advantage of the data display and data display method of the invention is that it aids comprehension and data mining as well as recognition of patterns and prediction of events.

In one aspect, there is provided a method of displaying data including: sorting documents in a data set into a set of categories; assigning an indicia to each category in the set of categories; displaying each document as one or more respective cell comprising a respective indicia, grouping the cells comprising an identical indicia and displaying each group of the grouped cells as a component of a complex object to thereby display the data.

In one embodiment of the first aspect the method may further include the step of receiving the data set.

In another embodiment of the first aspect the method may further include the step of outputting the display.

In a second aspect the invention provides a data display comprising: a complex object comprising one or more group comprising grouped cells, each group representing a category in a set of categories and comprising a plurality of cells comprising an identical indicia, each cell representing a respective document comprised in a data set.

According to the second aspect the data set may be sorted into the set of categories.

In a third aspect the invention provides a system for displaying data comprising: a processor for sorting documents in a data set into a set of categories, assigning one or more indicia to each document, each respective indicia being allocated to a group corresponding to a respective category in the set of categories, and grouping the identical indicia; a display for displaying each indicia so that grouped indicia form a group and the one or more group forms a complex object.

In one embodiment of the third aspect the system may further comprise an input for receiving a data set.

In another embodiment of the third aspect the system may further comprise an output for outputting the display or data comprising the display.

In a fourth aspect the invention provides a display displaying data according to the method of the first aspect.

In a fifth aspect the invention provides a system for displaying data according to the method of the first aspect.

In a sixth aspect the invention provides a computer program product comprising: a computer usable medium and computer readable program code embodied on said computer usable medium for displaying data, the computer readable code comprising: computer readable program code devices (i) configured to cause the computer to sort documents in a data set into a set of categories; computer readable program code devices (ii) configured to cause the computer to assign one or more indicia to each category in the set of categories; and computer readable program code devices (iv) configured to cause the computer to display each indicia, group the cells having an identical indicia into a one or more group and display one or more group to form a complex object to thereby display the data.

According to any above aspect the complex object may be an object that may grow, shrink and/or otherwise change or develop.

According any above aspect the growth may be in one, two, three or four dimensions.

According any above aspect the complex object may be an ecologically valid visual display that is familiar to a user.

According to any above aspect in one embodiment the complex object may be a tree.

According to any above aspect the complex object may comprise one or more feature.

According to any above aspect each feature of the one or more feature may comprise one group.

According to any above aspect in one embodiment the one or more feature may be associated with the complex object.

According to any above aspect when the complex object is a tree, the feature may be a branch, a leaf, a flower, a fruit, a bird or a bee.

According to any above aspect when the complex object is a tree, the growth, shrink and/or other change or develop may comprise growth of branches and leaves and well as dying off of branches and leaves.

According to any above aspect the one or more indicia may be a symbol, colour, character, number, word, letter, shape, shade, size, font, sound or any other suitable identifier or combination of these.

In one embodiment of any above aspect the one or more indicia may be a colour.

The method, display, system and computer program product according to any of the above aspects wherein the categories may be user-selected.

The method, display, system and computer program product according to any of the above aspects wherein one or more area of the display may be zoomed in and/or out of.

The method, display, system and computer program product according to any of the above aspects further comprising a selection tool or cursor that may move around the display.

The method, display, system and computer program product according to any of the above aspects wherein the display may further comprise the categories and/or document titles or a subset thereof.

The method, display, system and computer program product according to any of the above aspects wherein a cell representing a document comprising one or more search term may be highlighted.

The method, display, system and computer program product according to any of the above aspects wherein a document comprised in the data set may be opened by clicking on the respective cell or displayed title.

The method, display, system and computer program product according to any of the above aspects wherein the display may be viewed from various perspectives, including elevation and plan view and/or stereoscopic view.

The method, display, system and computer program product according to any of the above aspects may comprise a dimension of time.

The method, display, system and computer program product according to any of the above aspects may display data in either 2D, 3D or 4D.

The method, display, system and computer program product according to any of the above aspects wherein the tree and or branch or branches may be grown or shrunk at variable speeds, paused and/or stepped frame by frame.

The method, display, system and computer program product according to any of the above aspects wherein one document may be sorted into two or more categories.

The method, display, system and computer program product according to any of the above aspects wherein components of the complex object may be produced automatically as a result of bottom-up self-organisation.

The components of the complex object may be the tree and branch or branches.

The components of the complex object produced automatically as a result of the bottom-up self-organization may be directly affected and/or formed by user-generated upload

The method, display, system and computer program product according any of the above aspects wherein one or more cell is grouped together based on a relationship of the associated documents.

The method, display, system and computer program product according to any of the above aspects wherein multiple complex objects or trees may be created to populate a virtual collection or complex objects or forest.

The method, display, system and computer program product according to any of the above aspects wherein the display is in real time and may change with respect to a change in the data set.

The display may change in real as a result of one or more user generated upload.

In one embodiment according to any of the above aspects the display may be a digital display.

In one embodiment according to any of the above aspects the display may be dynamic.

The method, display, system and computer program product according to any of the above aspects may display qualitative and/or quantitative data.

The method, display, system and computer program product according to any of the above aspects may display differential intensity of data.

The method, display, system and computer program product according to any of the above aspects may display differentiate a growth trajectory of a data sets or of a category.

The method, display, system and computer program product according to any of the above aspects wherein the data set may be received from another program or device or one or more user.

As used herein, except where the context requires otherwise, the term “comprise” and variations of the term, such as “comprising”, “comprises” and “comprised”, are not intended to exclude further additives, components, integers or steps.

Further, as exemplified herein, the method, display and system of the invention may be dynamic and may display any change in the data set. The change may be displayed with time (temporally).

As used herein an indicia may be a symbol, colour, character, number, word, letter, shape, shade, size, font, sound or any other suitable identifier or combination of these. In one particular embodiment the one or more indicia is a colour. When colour is used for indicia, the colour indicia may be aligned with a corresponding musical tone so a user can recognise a type of incoming data by sound.

As used herein a complex object may be any object comprising one or more feature. In one embodiment the complex object is a common place object such as a tree, a building, a crane, an animal or a bacteria. From the teaching herein the skilled person will understand that other complex objects may be selected based on, for example, the data set or audience. For example, when the data set comprises sporting information the complex object may be an athlete, sporting apparel, sporting equipment or ball. In another example, the complex object when the audience is from within the same company, the complex object may be selected to be associated with the company such as, a logo, product, building or representative.

In a preferred embodiment the complex object may be an ecologically valid visual display which herein is understood to mean a biomimetic visual metaphor that exploits familiar organic structures to maximise intuitive understanding, that is, rapid cognition of their complexity.

As will be clear from the above, the complex object may be an object that may grow, shrink or otherwise change and/or develop. The growth, shrinking or other change or development may be in one, two, three or four dimensions.

The complex object may comprise one or more feature. The one or more feature maybe associated with the complex object. For example, when the complex object is a tree, the feature may be a branch, a fruit, a flower, a bird or a bee.

Further, when the complex object is a tree, the growth, shrink and/or other change or development may comprise growth of branches and leaves and well as dying off of branches and leaves.

The one or more feature may comprise one group of the cells grouped by indicia.

In one embodiment the present invention converts text-based documents and/or files into colour-coded cells, and works especially well offering improved data display for complex information. The invention presents the information contained in any data set in a user friendly way, enabling much faster navigation and comprehension. Advantageously, the present invention gives a user a whole-field view of a data set, no matter how large, where all the information is on the screen at once. Of further significant advantage is that the display may be updated on demand or automatically in real time.

The present invention may also allow a user to browse, find, file and retrieve information in a much faster way than current two dimensional and cumbersome practice permits. The present inventor's contribution also enables a user to observe the evolution of the data as a whole, that is, to understand growth patterns and thus make more accurate predictions.

The present invention is a ‘blue economy’ innovation that uses the latent energy in the information matrix to produce rich and increasing returns for minimal energy cost. It is a build-on application that can be used for any data set, including but not limited to, those listed below.

Data display is a key constraint in the information economy and the innovative solution provided by the present invention will play a critical role at the confluence of key environmental factors including:
The National Broadband Network;
Cloud computing (converged infrastructure);
Increasing use of mobile data display hardware on tablets and smart phones;
Highly efficient search engines; and
Social media.

These factors combine to allow access to very large data sets at very fast speeds.

The user, however, is constrained by the limited number of words that can fit on a computer screen. The present invention allows a user to access and exploit large amounts of real-time information in ways that are not currently available.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The invention will be displayed with reference to a tree. However, the invention is not so limited and almost any complex object may be substituted for the tree.

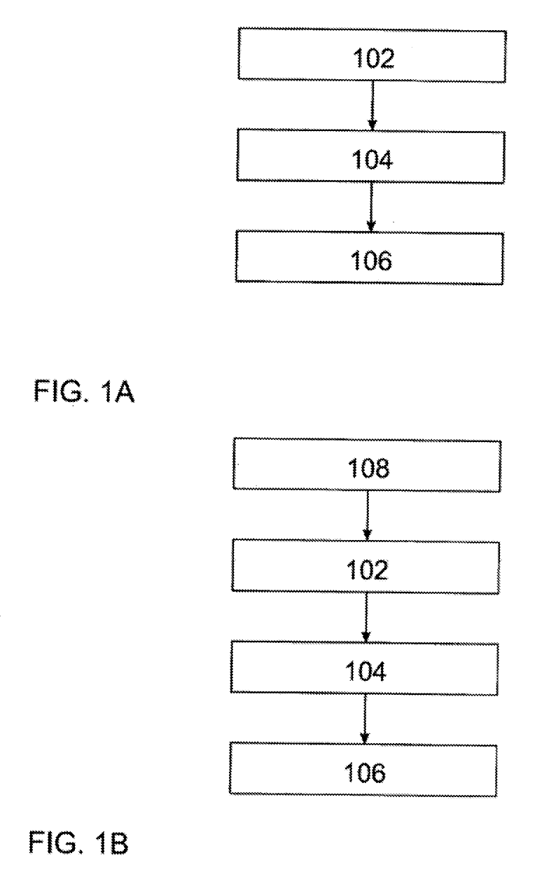

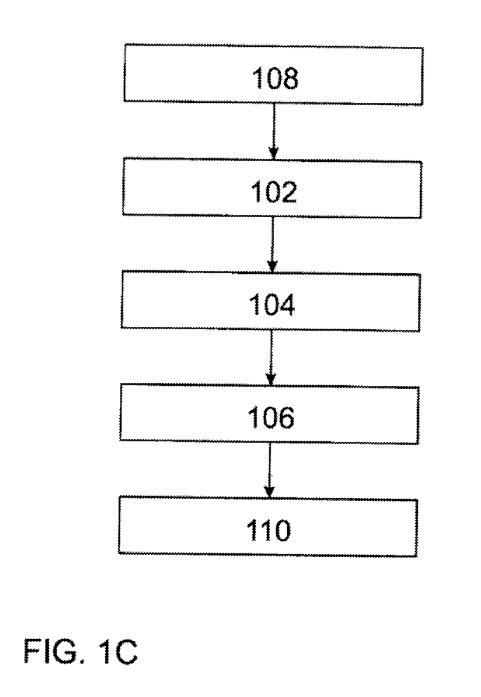

FIG. 1A shows one embodiment of a method 100 of displaying data according to the invention.

In step 102 documents in a data set are sorted into a set of categories.

The data set may be made up of information contained in a database, a catalogue, a large document, a web search, a filing system and/or social media database or just about any dataset of any size, including the world wide web.

The categories comprised in the set of categories may be user-selected. As they may be user-selected the category number and type is essentially unlimited. As will be appreciated from the teaching herein, the categories may be selected according to whatever taxonomy regulates the data set. Although not limited thereto, example categories include: contain a keyword, phrase or text; contain a theme; document type; associated with a particular person; associated with a particular type of person; associated with an address or other geographical location; associated with ownership or a product; associated with income; position; business department; alphanumeric or other code; and/or telephone number.

In step 104 an indicia, in this example a color, is assigned to each category in the set of categories. The color may also be selected by a user.

In step 106 each document is displayed as a respective colored cell and the coloured cells having an identical colour are grouped into a branch and the branch or branches displayed to form a tree to thereby display the data.

The grouping may further include positioning associated cells together. The positioning may spatial and may be proximal or distal. The positioning may be related to a relationship, strength or weakness of a relationship between two documents.

FIG. IB shows another embodiment of method 102 which includes the additional step 108 of receiving a data set. The data set may be received from any source including those inputs described below.

FIG. 1C shows another embodiment of method 102 which includes the additional step 110 of outputting the display. The display may be output through similar means as described above with respect to receiving the data set.

The present specification also discloses apparatus for performing the operations of the methods. Such apparatus may be specially constructed for the required purposes, or may comprise a general purpose computer or other device selectively activated or reconfigured by a computer program stored in the computer. Suitable apparatus include a personal computer, mobile phone or personal digital assistant (PDA).

The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer is described below.

In addition, the present specification also implicitly discloses a computer program or a computer program product, in that it would be apparent to the person skilled in the art that the individual steps of the method described herein may be put into effect by computer code.

The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Additionally, one or more steps of the computer program may be performed in parallel rather than sequentially.

The computer program may be stored on any computer readable medium as a computer program product. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

In one embodiment the computer program product may comprise a computer usable medium and computer readable program code embodied on said computer usable medium for implementing the steps of the method 100 of the invention.

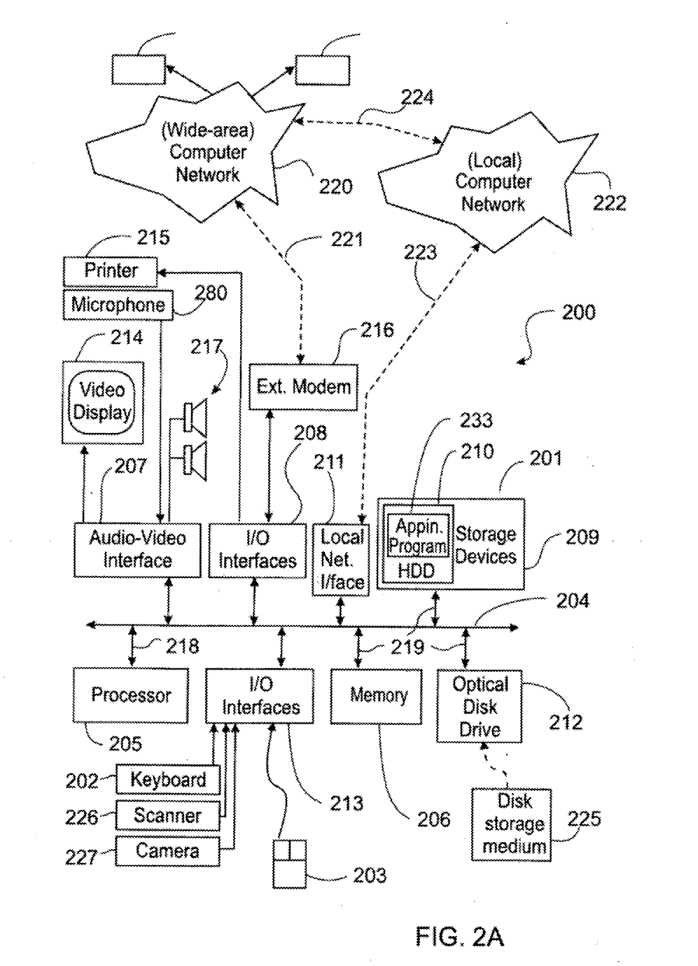

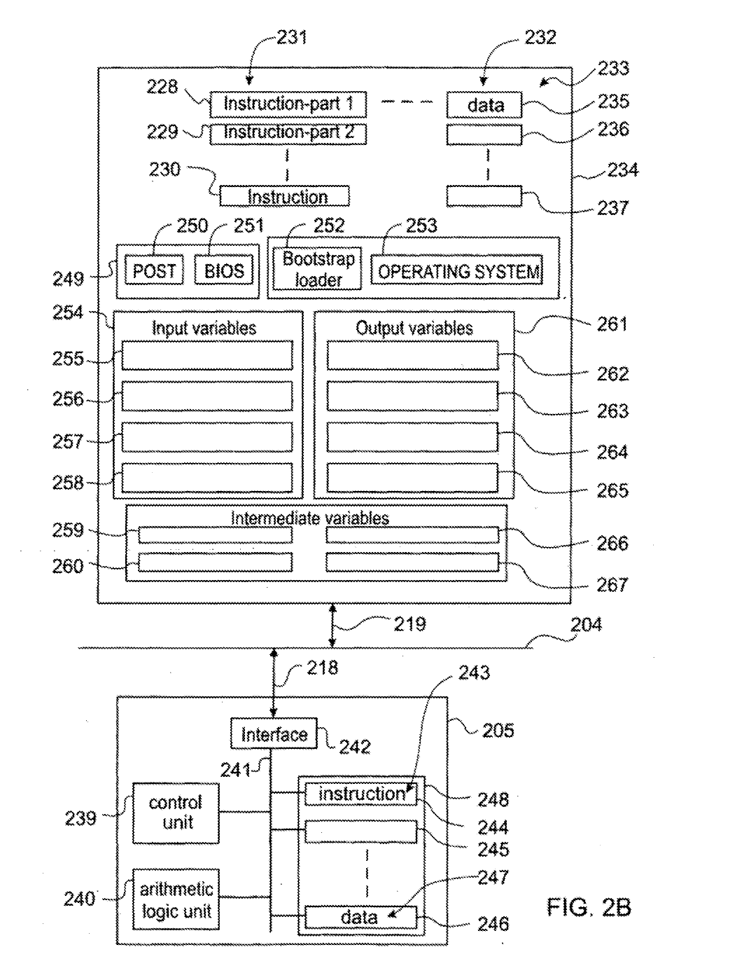

One embodiment of a computer system 200 suitable for use in the present invention is shown in FIG. 2A. the computer system 200 is formed by a computer module 201, input devices such as a keyboard 202, a mouse pointer device 203, a scanner 226, a camera 227, and a microphone 280, and output devices including a printer 215, a display device 214 and loudspeakers 217. An external Modulator-Demodulator (Modem) transceiver device 216 may be used by the computer module 201 for communicating to and from a communications network 220 via a connection 221. The network 220 may be a wide-area network (WAN), such as the Internet or a private WAN. Where the connection 221 is a telephone line, the modem 216 may be a traditional “dial-up” modem. Alternatively, where the connection 221 is a high capacity (e.g.: cable) connection, the modem 216 may be a broadband modem. A wireless modem may also be used for wireless connection to network 220.

The computer module 201 typically includes at least one processor 205, and a memory 206 for example formed from semiconductor random access memory (RAM) and semiconductor read only memory (ROM). The module 201 also includes an number of input/output (I/O) interfaces including an audio-video interface 207 that couples to the video display 214, loudspeakers 217 and microphone 280, an I/O interface 213 for the keyboard 202, mouse 203, scanner 226, camera 227 and optionally a joystick (not illustrated), and an interface 208 for the external modem 216 and printer 215. In some implementations, the modem 216 may be incorporated within the computer module 201, for example within the interface 208. The computer module 201 also has a local network interface 211 which, via a connection 223, permits coupling of the computer system 200 to a local computer network 222, known as a Local Area Network (LAN). As also illustrated, the local network 222 may also couple to the wide network 220 via a connection 224, which would typically include a so-called “firewall” device or device of similar functionality. The interface 211 may be formed by an Ethernet circuit card, a Bluetooth wireless arrangement or an IEEE 802.11 wireless arrangement.

The interfaces 208 and 213 may afford either or both of serial and parallel connectivity, the former typically being implemented according to the Universal Serial Bus (USB) standards and having corresponding USB connectors (not illustrated).

Storage devices 209 are provided and typically include a hard disk drive (HDD) 210. Other storage devices such as a disk drive and a magnetic tape drive (not illustrated) may also be used. An optical disk drive 212 is typically provided to act as a non-volatile source of data. Portable memory devices, such optical disks (e.g.: CD-ROM, DVD), USB-RAM, and floppy disks for example may then be used as appropriate sources of data to the system 200.

The components 205 to 213 of the computer module 201 typically communicate via an interconnected bus 204 and in a manner which results in a conventional mode of operation of the computer system 200 known to those in the relevant art. Examples of computers on which the described arrangements can be practiced include IBM-PC's and compatibles, Sun Sparc stations, Apple Mac or alike computer system evolved therefrom.

FIG. 2B is a detailed schematic block diagram of the processor 205 and a memory 234. The memory 234 represents a logical aggregation of all the memory modules (including the storage device 209 and semiconductor memory 206) that can be accessed by the computer module 201 in FIG. 2 A.

The method 100 may be implemented using the computer system 200 wherein method 100 may be implemented as one or more software application programs 233 executable within computer system 200. In particular, the steps of the method 100 are affected by instructions 231 in the software that are carried out within the computer system 200.

The software instructions 231 may be formed as one or more code modules, each for performing one or more particular tasks. The software may also be divided into two separate parts, in which a first part and the corresponding code modules performs the method 100 and a second part and the corresponding code modules manage a graphical user interface between the first part and the user.

The; software may be stored in a computer readable medium, including in a storage device of a type described herein. The software is loaded into the computer system 200 from the computer readable medium, and then executed by the computer system 200. A computer readable medium having such software or computer program recorded on it is a computer program product. The use of the computer program product in the computer system 200 preferably affects an advantageous apparatus for implementing the method 100.

The software 233 is typically stored in the HDD 210 or the memory 206. The software is loaded into the computer system 200 from a computer readable medium, and then executed by the computer system 200. Thus for example the software 233 may be stored on an optically readable CD-ROM medium 225 that is read by the optical disk drive 212. A computer readable medium having such software or computer program recorded on it is a computer program product. The use of the computer program product in the computer system 200 preferably affects an advantageous apparatus for implementing the method 100. In some instances, the application programs 233 may be supplied to the user encoded on one or more CD-ROM 225 and read via the corresponding drive 212, or alternatively may be read by the user from the networks 220 or 222. Still further, the software can also be loaded into the computer system 200 from other computer readable media. Computer readable storage media refers to any storage medium that participates in providing instructions and/or data to the computer system 200 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 201. Examples of computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon display 214. Through manipulation of, typically, keyboard 202 and mouse 203, a user of computer system 200 and method 100 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers 217 and user voice commands input via microphone 280.

When the computer module 201 is initially powered up, a power-on self-test (POST) program 250 executes. The POST program 250 is typically stored in a ROM 249 of the semiconductor memory 206. A hardware device such as the ROM 249 is sometimes referred to as firmware. The POST program 250 examines hardware within the computer module 201 to ensure proper functioning, and typically checks processor 205, memory (209, 206), and a basic input-output systems software (BIOS) module 251, also typically stored in ROM 249, for correct operation. Once the POST program 250 has run successfully, BIOS 251 activates hard disk drive 210. Activation of hard disk drive 210 causes a bootstrap loader program 252 that is resident on hard disk drive 210 to execute via processor 205. This loads an operating system 253 into RAM memory 206 upon which operating system 253 commences operation. Operating system 253 is a system level application, executable by processor 205, to fulfil various high level functions, including processor management, memory management, device management, storage management, software application interface, and generic user interface.

Operating system 253 manages memory (209, 206) in order to ensure that each process or application running on computer module 201 has sufficient memory in which to execute without colliding with memory allocated to another process. Furthermore, the different types of memory available in the system 200 must be used properly so that each process can run effectively. Accordingly, the aggregated memory 234 is not intended to illustrate how particular segments of memory are allocated (unless otherwise stated), but rather to provide a general view of the memory accessible by computer system 200 and how such is used.

The processor 205 includes a number of functional modules including a control unit 239, an arithmetic logic unit (ALU) 240, and a local or internal memory 248, sometimes called a cache memory. The cache memory 248 typically include a number of storage registers 244-246 in a register section. One or more internal busses 241 functionally interconnect these functional modules. The processor 205 typically also has one or more interfaces 242 for communicating with external devices via the system bus 204, using a connection 218.

Application program 233 includes a sequence of instructions 231 that may include conditional branch and loop instructions. The program 233 may also include data 232 which is used in execution of the program 233. The instructions 231 and the data 232 are stored in memory locations 228-230 and 235-237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228-229.

In general, processor 205 is given a set of instructions which are executed therein. The processor 205 then waits for a subsequent input, to which it reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader (ODD) 212. The execution of a set of the instructions may in some cases result in output of data. Execution may also involve storing data or variables to the memory 234.

The disclosed arrangements use input variables 254 that are stored in the memory 234 in corresponding memory locations 255-258. The described arrangements produce output variables 261 that are stored in the memory 234 in corresponding memory locations 262-265. Intermediate variables may be stored in memory locations 259, 260, 266 and 267.

The register section 244-246, the arithmetic logic unit (ALU) 240, and the control unit 239 of the processor 205 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from memory location 228;

(b) a decode operation in which control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232. Each step or sub-process in the processes of FIGS. 1 A and IB is associated with one or more segments of the program 233, and is performed by register section 244-247, the ALU 240, and the control unit 239 in the processor 205 working together to perform the fetch, decode, and execute cycles for every instruction in the instruction set for the noted segments of program 233.

One or more client computers 270, 271 may be connected to the communications network 220 as seen in FIG. 2A. Each of the computers 270, 271 has a similar configuration to the computer module 201 and corresponding peripherals.

Method 100 may alternatively be implemented in dedicated hardware such as one or more integrated circuits performing the functions or sub functions of the described methods. Such dedicated hardware may include graphic processors, digital signal processors, or one or more microprocessors and associated memories.

The invention also provides a data display 300. The data display 300 may be displayed on a monitor such as display device 214.

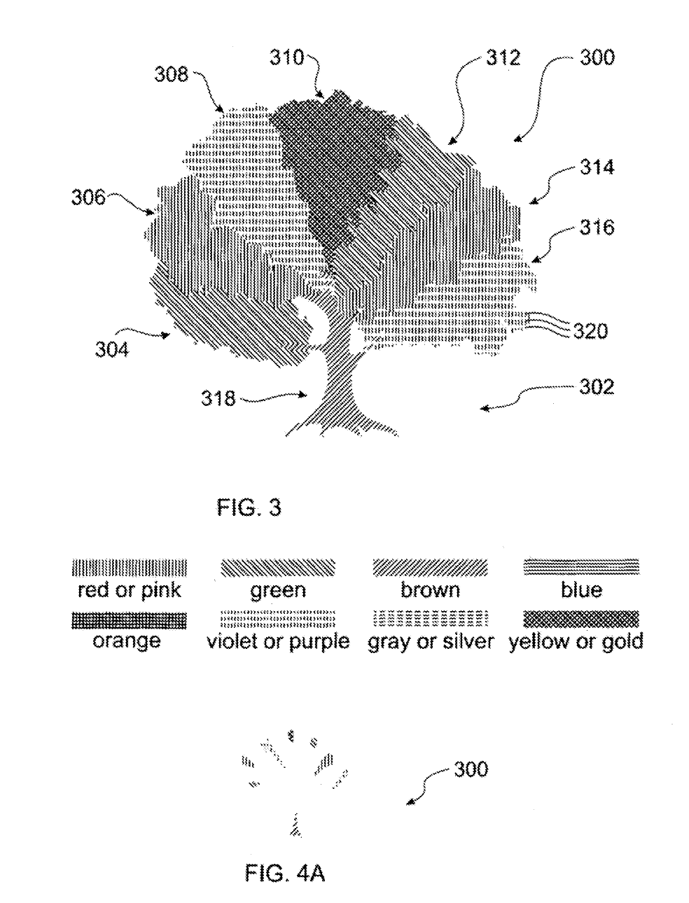

One embodiment of a data display according to the invention, data display 300 is shown in FIG. 3 which displays a tree 302 comprising a plurality of colored branches 304-316. For display purposes tree 302 also comprises a trunk 318.

FIG. 3 shows seven branches 304-316, however the invention is not so limited. A tree 302 may comprise any number of branches as selected by the user. A tree 302 may comprise 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 100, 150, 200, 500, 1000 or more branches. Based on the teaching herein a skilled person readily understands that the number of branches may be selected to suit the number of categories the skilled person wishes to see displayed.

The colors of branches 304-316 are: dark green 304; red 306; light blue 308; yellow 310; light green 312; pink 314; and dark blue 316. A user may select from these colors or use any other color.

As described above each colored branch 304-316 represents a category in a set of categories and comprises one or more identically colored cells 320. The colored cells 320 represent a respective document comprised in the data set. That is, if a document is sorted into category represented by branch 304, a cell representing that document is comprised in branch 304.

As shown in FIG. 3, two different shades of green 304, 312 and red/pink 306, 314 are used. It is to be understood that the two different green 304, 312 and pink 306, 314 regions in FIG. 3′ comprise different indicia, groups and components.

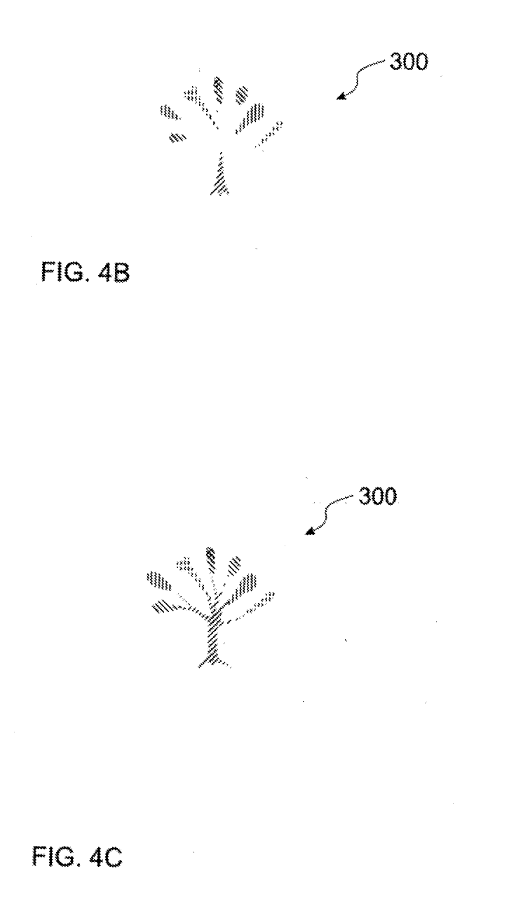

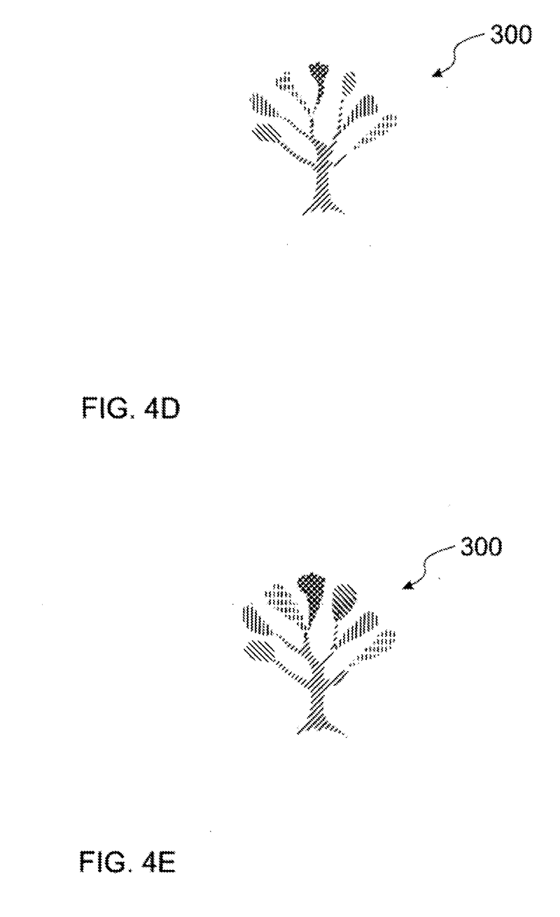

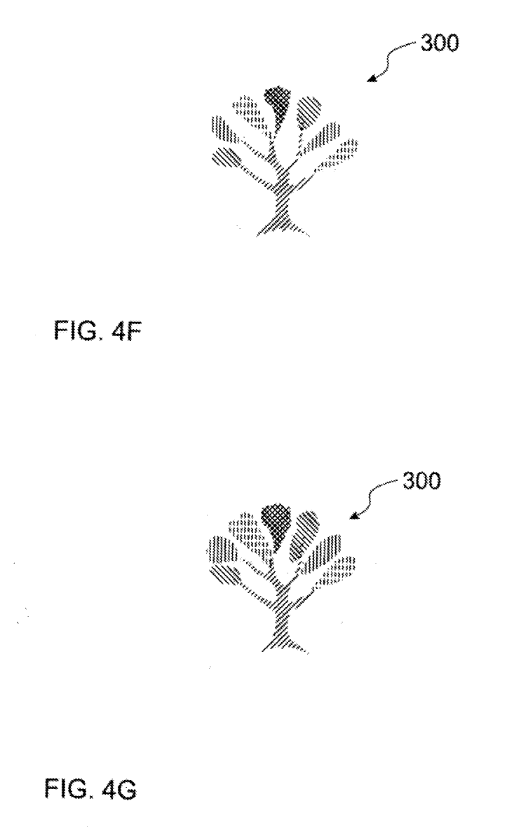

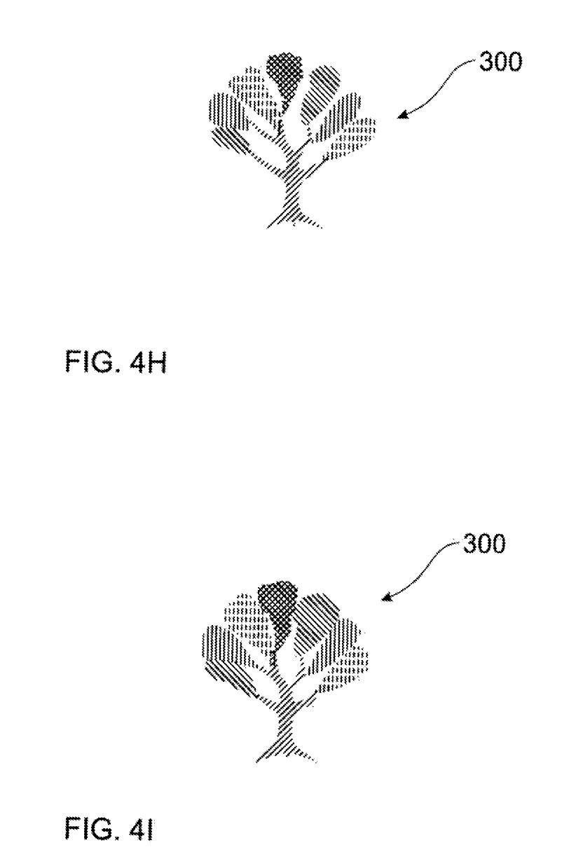

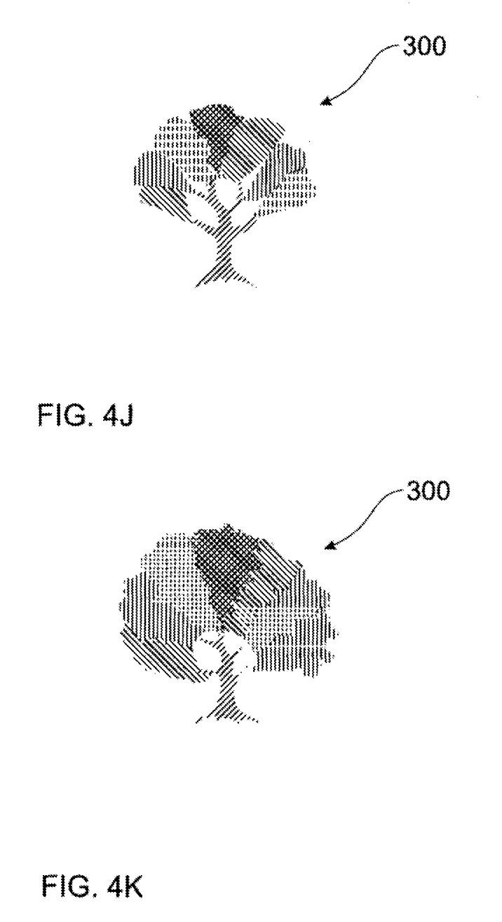

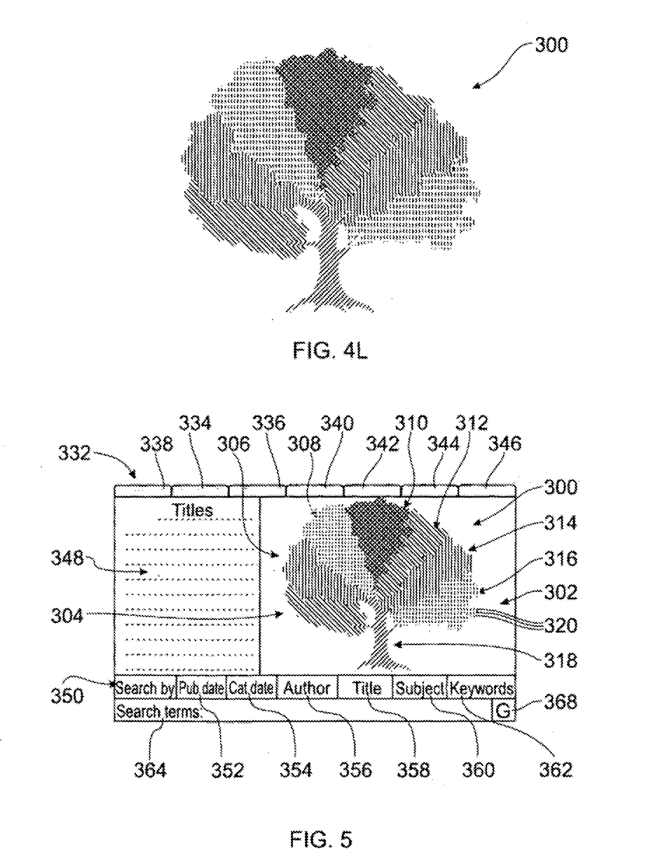

In some instances color displays are not possible. Accordingly, the colour figures of the invention are also shown in black and white and identified with a “′”, so for example the black and white version of FIG. 3 is labeled as FIG. 3′. FIG. 3′ shows the same embodiment of FIG. 3 in a black and white display. The legend or key for the black and white shadings to color indication are show below the display. Black and white FIGS. 4A′-4L′, 5′, 6′, 7′, 8A′-8C′ and 9 use the same legend as shown in FIG. 3′ to the same embodiment as their respective color FIGS. 4A-4L, 5, 6, 7, 8A-8C and 9. Any reference to the color figures applies in the same manner to the black and white figures with the required change from color to the respective shading.

The size of a branch 304-316 will depend on the number of cells 320 and thereby on the number of documents sorted into a respective category.

From the teaching herein it is clear that one document may be sorted into two or more categories.

Display 300 may change in real time as the data set changes. For example, if the data set changes to include additional documents sorted into the category represented by branch 304, more cells 320 will be comprised in branch 304. FIGS. 4A-4L show tree 300 growing as the data set increases. Due to copying restraints, this aspect of growth in an on-paper display may be clearer in the black and white FIGS. 4A′ to 4L′.

This dynamic nature of display 300 has great advantage in fields where prediction or recognition of an event or pattern is of interest.

Tree 300 may be accompanied by additional graphical user interface (GUI) elements 330. A user can use the GUI 330 to initiate various commands to interact with display 300.

FIG. 5 shows one embodiment of a display 300 comprising additional GUI

elements 330 comprising top menu bar 332 which lists category buttons 334-346 corresponding to those categories represented by branches 304-316, respectively. Category buttons 334-346 have the same corresponding color as their respective branch 304-316, that is category button 334 is dark green, category button 336 is red, category button 338 is light blue, category button 340 is yellow, category button 342 is light green, category button 3444 is pink 314 and category button 346 is dark blue.

The invention may also provide a selection tool or cursor that a user may move around display 300. The selection tool may be operated by an input such as mouse pointer device 203, keyboard 202 and/or microphone 280.

GUI 330 also comprises list box 348 which displays the titles of documents in the data set. The title may be extracted from the title information stored in each individual document. List box 348 may also display document type by displaying a document file extension, e.g. .doc, jpg etch

The list setting controlling list box 348 may be set by a user to for example, display the title of all documents in the data set in an order such as, alphabetical, size, type or time of last edit.

In another embodiment the list setting controlling list box 348 may be set by a user to display the title of all documents that the selection tool or cursor is on, adjacent to and/or comprised within a cursor selection tool sized with mouse pointer device 203. The parameter for “adjacent” may be set by a user. Suitable parameters may be within 1000, 500, 200, 100, 50, 20 or 10 cells of the cursor.

The selection tool or cursor may be adjusted to select areas of any size.

As the selection tool or cursor moves around the tree 302, titles may spin through the list box like microfiche.

The titles displayed in list box 348 may update dynamically as the selection tool or cursor moves across display 300 and/or as the contents of the data set change.

The view setting controlling list box 348 may be set by a user to display a user selected view type. In one embodiment a user may select from “filmstrip”, “thumbnail”, “tiles”, “icons”, “list” or “details” view types.

A further development by the present inventor of particular advantage is that one or more cell 320 representing one or more document containing a term may be highlighted on tree 300.

The highlighting may he achieved by searching for documents containing for example, a relevant term, which can be done through search bar 350. A user may select the search type by selecting an appropriate search button 352-362. In the embodiment shown in FIG. 5 the search buttons 352-362 are publication date 352, catalogue date 354, author 356, title 358, subject 360 and key words 362. Once the appropriate search button 352-362 is selected, for example by clicking on with a mouse pointer device 203, the search term may be entered with keyboard 202 in search term entry box 364 and the search initiated by clicking the go button 368 with mouse 203 or pressing the enter key on keyboard 202.

When a search term is entered, the hits may be highlighted in clusters. This aids interpretation and interaction with display 300.

Display 300 may be viewed from any perspective, including elevation and plan view. Additionally, as a 2D or 3D image the tree can be rotated through both axes. The display may also be presented as a stereoscopic dual image to create a lucid 3D effect.

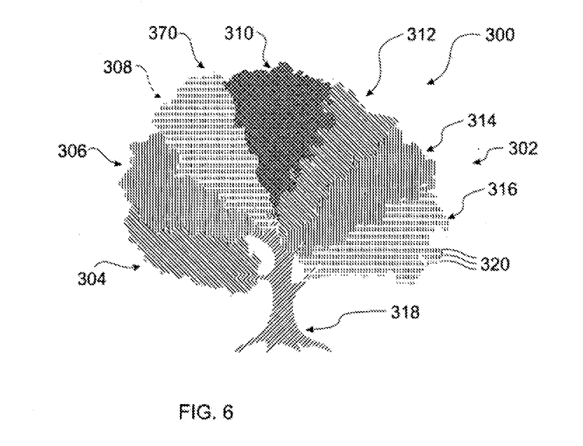

Advantageously, an elevation view may show the history of how the subject has grown over time. FIG. 6 shows an example of an elevation view of display 300 in which highlighted cells 370 are shown in white.

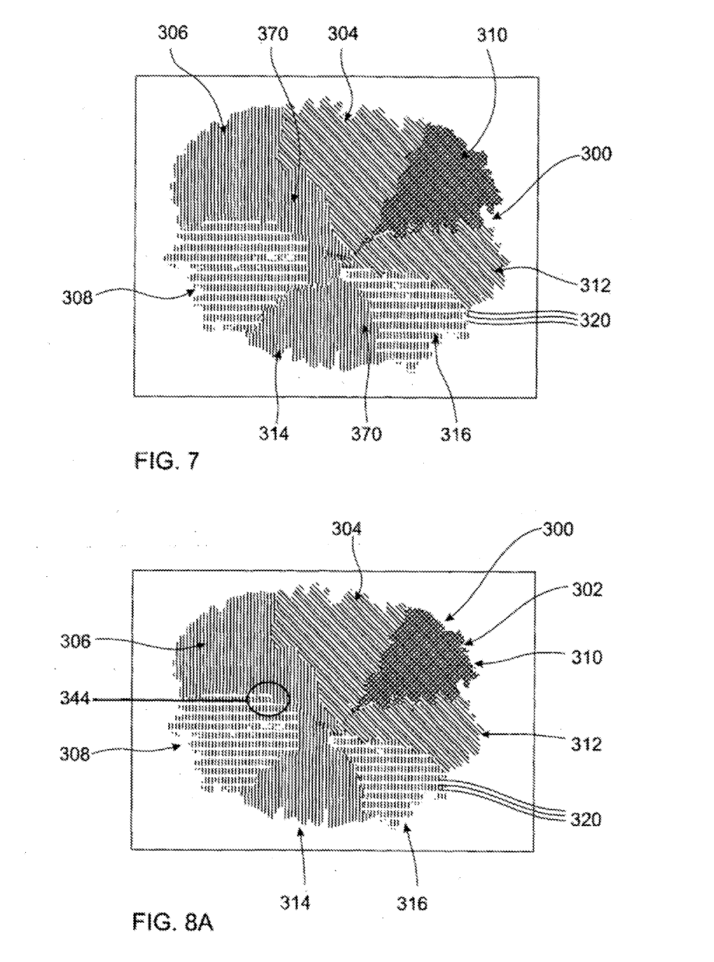

The present invention also allows a user to view the display 300 from all sides and from different views such as, the plan view shown in FIG. 7. A viewing perspective may be changed by moving mouse pointer device 203.

FIG. 7 also shows some highlighted cells 370 in white. By moving to the plan view, highlighted cells 370 in branch 306 that weren't visible in FIG. 6 may be seen.

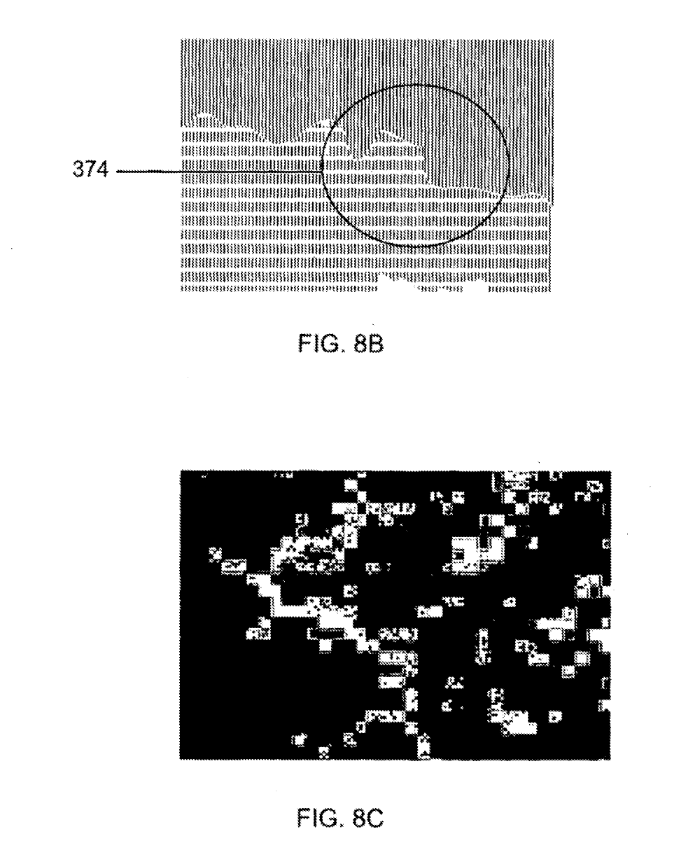

The present invention also allows zooming in and zooming out of display 300. FIGS. 8A-8C illustrate zooming in on highlighted cells 370 in branches 306 and 308. Zooming in may be accomplished through manipulation of mouse pointer device 302 to select and size a cursor selection tool 374 on the desired part of tree 302. FIG. 8A shows the sizing and location of cursor selection tool 374. FIG. 8B shows initial zooming in and FIG. 8C shows further zooming in. A user may select the amount of zoom in or zoom out. The zooming in and zooming out may be unlimited.

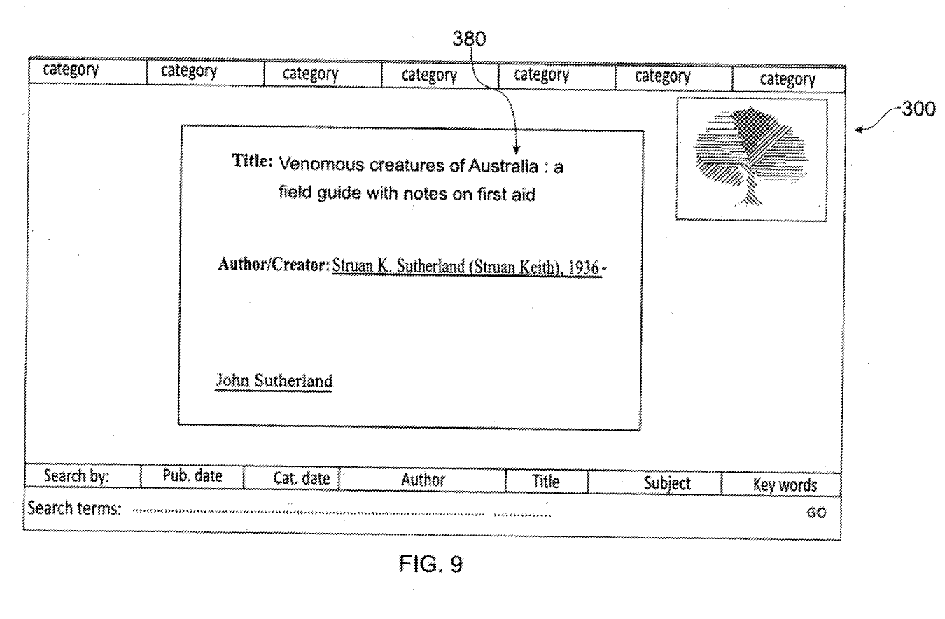

A document associated with a respective cell 320 may be opened by clicking on the respective cell 320. FIG. 9 shows document 380 open in display 300.

System 200 may be used for displaying data according to the invention. In one embodiment system 200 may comprise processor 205 for sorting documents in a data set into a set of categories, assigning an indicator to each document, each respective indicator allocated a color corresponding to a respective category in the set of categories, and grouping the indicators having an identical colour.

In a further embodiment system 200 further comprises display device 214 for displaying each indicator as a respective colored cell so that grouped indicators form a branch and the braches form a tree.

In yet another advantageous embodiment system 200 further comprises an input for receiving the data set. Examples of a suitable input include keyboard 202, mouse pointer device 203, local computer network 222, wide network 220 and/or CD ROM medium 225.

In another embodiment system 200 comprises an output for outputting the display or data comprising the display. Examples of a suitable output include keyboard 202, mouse pointer device 203, local computer network 222, wide network 220 and/or CD ROM medium 225.

The present invention may find application to any kind of data set. For example, the invention may be used in financial, academic, business, statistical, survey, marketing, medical, safety, email, social media, education, training, OHS systems and practitioners, econometrics, bioinformatics, social media users and owners such as email, Facebook and Twitter, search engine users and owners such as Google and Yahoo, community resources such as Wikipedia, library systems, business management, insurance and sport.

The data set may comprise any kind of data. In this way the method 100, display 300 and system 200 according to the invention may display qualitative and/or quantitative data.

The method, display and system according to any of the above aspects may display differential intensity of data. The intensity may be displayed as differential hue and/or depth of colour. As such, the differential intensity displays a heat map, where increased intensity is displayed as increased heat or brighter hue or stronger depth of colour. Intensity may also be displayed as differential size, shape or type of feature.

As mentioned above cells grouped together may also be positioned within the grouping based on a relationship of the associated documents. The positioning may be spatial and may be proximal or distal. The positioning may be related to a relationship, strength or weakness of a relationship between two or more documents.

As mentioned above the present invention may comprise a dimension of time. The data set and corresponding display 300 may change with time or another parameter.

From the teaching herein the skilled person will understand that the dynamic nature of the present invention means that display 300 may differentiate a growth trajectory of a data set or of a category.

The dynamic nature of the invention has a further advantage in that the tree and or branches may be grown or shrunk at variable speeds, paused and/or stepped frame by frame.

A further advantage of the present invention is that it may use any data set, including a data set formatted from one or more other software program.

The display 300, tree 302 and branches 304-316 may be produced automatically as a result of bottom-up self organisation. In a particular embodiment a user or users may themselves upload directly to the display.

Although not shown display 300 may comprise a plurality of trees 300. When a plurality of trees 302 are displayed the display may comprise a virtual forest.

The following non-limiting examples illustrate the present invention. These examples should not be construed as limiting; the examples are included for the purposes of illustration only. The Examples will be understood to represent an exemplification of the invention.

### EXAMPLES

### Example

### Public Sector

Freedom of information legislation leads to a build up of archived information. The present invention may be applied in government departments currently using cumbersome archiving systems such as, TRIM and information clearing houses such as the Australian Bureau of Statistics will find increased efficiencies with the present invention.

### Example

### Social Media

The @Twitter Blog reports that users were tweeting 5,000 times a day in 2007. By 2008, that number was 300,000, and by 2009 it had grown to 2.5 million per day. Tweets grew 1,400% last year to 35 million per day. Today, we are seeing 50 million tweets per day—an average of 600 tweets per second. Using the present invention the highly dynamic Twitter environment can be observed as it evolves in real time and the twitter sphere can be analysed in seconds, zooming in and out of areas identified by size/intensity/colour as ‘trending’. This example is of particular appeal to marketers who can grow and shrink the twitter-tree's to observe critical points in time and use this information for predicting and planning

### Example

### Web Search

The Google search engine is able to retrieve hundreds of millions of hits in a split second but this is mostly redundant as users can only address a handful of web pages at a time. The instant invention presents all the hits at once in a way that allows users to find useful items much faster and, importantly, notice areas of potential interest that they would never have known about previously.

### Example

### Library systems

The Australian Library and Information Association (ALIA) cites over 500 local government libraries and 8 national and state libraries operating in Australia serving 7 million active registered borrowers. This does not include libraries in universities, TAPE and schools, as well as research and specialist libraries in federal and state/territory government organisations and libraries in corporations and other non-government organisations. Using the present invention it is possible to view the items in all these libraries on a single screen, find items faster and access higher levels of information currently unavailable due to time and effort.

### Example

### Education and Training

There are currently 63 endorsed Training Packages in the Australian

Qualifications Framework (in which about half of our education export income is earned.) Training packages are divided into Certificates and Diplomas made up of Units of Competency (UoC). Each UoC is made up of Elements of Competency, which in turn are aligned with Performance Criteria. There are tens of thousands of performance criteria and currently a significant level of redundancy due to replication. The present invention can be applied to rationalize and consolidate and to eliminate waste as well as to the recognition of prior learning and recognition of current competency (RPL and RCC). Using the present invention it will be possible to quickly and easily map competencies across a wide number of areas. This will reduce the current wasteful practice of delivering unnecessary training and assessment simply because it is easier and quicker than the recognition process. Example: Resources sector

The cost of OHS compliance in critical industries has increased significantly. OHS specialists are questioning the usefulness of current statistical analysis methods. While large amounts of data are collected and processed regarding near misses, lost time injuries and medical treatment injuries this information does not necessarily predict catastrophic incidents. The present invention allows safety trend analysis that may measure other variables not currently used and assist in predicting where major accidents are likely to occur

### Example

### Medical and Safety Management

Health professionals need to manage multiple different data sets to improve wellness, especially in view of multiple remote locations. The present invention allows these data sets to be combined as well as to allow analysis in real time for more efficient allocation of resources.

### Example

### Bioinformatics

A key area focuses on DNA (gene), RNA (message) and protein (amino acid) sequences, producing data as lists of letters (4 bases in the case of DNA and RNA; 20 types of amino acids in the case of proteins). Bioinformaticians are looking for ways of aligning related sequences and displaying them in a meaningful way. The problem is a combination of data overload and current tools that require expertise and experience. The present invention allows much easier and faster matching and analysis.

The advantages of the present invention include:
enables significant savings in time and effort currently expended on information management in all its forms at every level;
allows a user to grasp and exploit higher levels of knowledge in order to make better use of the information available;
enhances major infrastructure developments, specifically the National Broadband Network;
minimizes waste by taking a lean approach to information management and creates excess capacity through time-saving, leading to greater productivity;
information technology will become more accessible and people-friendly for everyday users as highly intuitive visual metaphors will promote inclusiveness for users e.g. the very young and the elderly, those with a non-English speaking background (or those working in a non-native language) and others with literacy difficulties.

The number of potential applications for the present invention is massive and almost unlimited. The present invention will find application for all computer users as the application works with data sets of any size, including the World Wide Web. search engines

Surprisingly, as exemplified herein the inventors have provided a data display and method which shows how an event or pattern initiates or develops and how they are linked to other areas of the data set at any moment in time. Thereby the present invention allows for prediction of future events. Such predictive value may find application in a wide variety of fields such as, financial, academic or business. The predictive application of the present invention may be likened to the way that satellite photography allows prediction of weather patterns.

Advantageously, the present invention groups data items with identical properties and displays them as a group so that change within the group is displayed rather than individual change. This novel display method makes it easier for a user to detect important patterns or key pieces of data and to recognise changes within a changing data set, such as a date set changing in response to data uploaded or added by a user.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method of displaying data comprising:
sorting documents in a data set into a set of categories;
assigning an indicia to each category in the set of categories, wherein an identical indicia is assigned to each document sorted into a respective category;
displaying each document as one or more respective cell comprising a respective indicia;
grouping the cells comprising an identical indicia; and
displaying each group of the grouped cells as a component of a complex object to thereby display the data.

2. The method of claim 1, further including the step of receiving the data set.

3. The method of claim 1, further including the step of outputting the display.

4. The method of claim 1, wherein the complex object comprises an object that may grow, shrink, and/or otherwise change or develop.

5. The method of claim 4, wherein the growth may be in one, two, three or four dimensions.

6. The method of claim 4, wherein one or more components of the complex object are produced automatically as a result of bottom-up self organisation.

7. A data display comprising:
a complex object comprising one or more group comprising grouped cells, each group representing a category in a set of categories and comprising a plurality of cells comprising an identical indicia, each cell representing a respective document comprised in a data set.

8. The data display of the claim 7, wherein the data set may be sorted into the set of categories.

9. The data display of claim 7, wherein the complex object comprises an object that may grow, shrink and/or otherwise change or develop.

10. The data display of claim 7, wherein the growth may be in one, two, three or four dimensions.

11. The data display of claim 7, wherein one or more components of the complex object are produced automatically as a result of bottom-up self organisation.

12. A system for displaying data comprising:
a processor for sorting documents in a data set into a set of categories, assigning one or more indicia to each document, wherein an identical indicia is assigned to each document sorted into a respective category, each respective indicia allocated a group corresponding to a respective category in the set of categories, and grouping the identical indicia;
a display for displaying each indicia so that grouped indicia form a group and the one or more group forms a complex object.

13. The system of claim 12, further comprising an input for receiving a data set.

14. The system of claim 12, further comprising an output for outputting the display or data comprising the display.

15. The system of claim 12, wherein the complex object comprises an object that may grow, shrink and/or otherwise change or develop.

16. The system of claim 12, wherein the growth may be in one, two, three or four dimensions.

17. The system of claim 12, wherein one or more components of the complex object may be produced automatically as a result of bottom-up self organisation.

18. A computer program product comprising:
a computer usable medium and computer readable program code embodied on said computer usable medium for displaying data, the computer readable code comprising:
computer readable program code devices (i) configured to cause the computer to sort documents in a data set into a set of categories;
computer readable program code devices (ii) configured to cause the computer to assign one or more indicia to each category in the set of categories, wherein an identical indicia is assigned to each document sorted into a respective category; and
computer readable program code devices (iii) configured to cause the computer to display each indicia, group the cells having an identical indicia into one or more group and display the one or more group to form a complex object to thereby display the data.

19. The computer program product of claim 18 wherein the complex object comprises an object that may grow, shrink and/or otherwise change or develop.

20. The computer program product of claim 18 wherein one or more components of the complex object may be produced automatically as a result of bottom-up self organisation.
